(19) United States
(12) Patent Application Publication
(10) Pub. No.: US 2023/0331345 A1
(43) Pub. Date: Oct. 19, 2023

(54) VEHICLE GEAR SHIFT SYSTEM

(71) Applicant: CA TECHNOLOGY SYSTEMS AS, Oslo (NO)

(72) Inventor: Knut Tore LJØSNE, Lom (NO)

(73) Assignee: CA TECHNOLOGY SYSTEMS AS, Oslo (NO)

(21) Appl. No.: 18/028,858

(22) PCT Filed: Sep. 23, 2021
(86) PCT No.: PCT/NO2021/050195

§ 371 Date: Mar. 28, 2023

(30) Foreign Application Priority Data
Sep. 29, 2020 (NO) 20201065

(51) Int. Cl. B62M 25/08; B62M 11/04; F16H 63/30; F16H 61/32; B62M 6/55

(52) U.S. Cl. CPC B62M 25/08; B62M 11/04; F16H 63/30; F16H 61/32; B62M 6/55; F16H 2063/3089

(57) ABSTRACT

A vehicle and a vehicle gear shift system includes a movable shift element configured to shift gears in a multispeed gear system of the vehicle; an energy source; and an energy storage element, wherein the energy source is configured to load or charge the energy storage element with potential energy, and the energy storage element is configured to move the shift element.

### TECHNICAL FIELD

The present invention relates to an improved gear shift system for a vehicle. The invention is of specific relevance for vehicles with multiple gears, where shifting is performed under torque and/or where the performance of the vehicle is seriously affected by the torque loss during shifting. Such vehicles could be e.g. pedally propelled vehicles where the pedaling is assisted by a motor, such as for an electric bicycle, but it may also be implemented in relation to gear shifting of multi-speed gear systems where no such motor-assist is available, or for motor-only driven vehicles, e.g. tractors or other heavy machinery

### BACKGROUND

As described initially, the invention can be used in a wide range of applications. One such application is pedally propelled vehicles.

Most pedally propelled vehicles, such as bicycles are equipped with some sort of selectable gear ratio to improve pedaling efficiency and comfort.

Different from gears in other types of vehicles that are motor driven, where a gear shift system and motor drive system can co-operate during the gear shift, a bicycle control system is not able to control the rider and the torque from the rider on the pedals in the same way.

Experienced riders have therefore developed their own understanding and application of a shifting scheme. The optimum shifting scheme will depend on the type of bicycle, the characteristics of the rider etc., which means that practically no shifting schemes will be the same.

This is cumbersome, and one can easily observe that less experienced, and even experienced riders struggle to shift gears efficiently in certain situations.

With the introduction of electrical bikes, where pedaling is supported by a motor drive, the same problem remains. The shift control system can control the contribution from the motor, but not from the rider.

While many experienced riders in the sport segment have accepted and even appreciate developing their own shifting scheme, shifting remains a hurdle for many riders, and for any pedally propelled vehicle with motorized support, such as standard pedelecs, moped style e-bikes, electric cargo vehicles with two or more wheels, mountain bikes, leisure bikes, commuter bikes etc., this problem is increasing with the number of such vehicles and riders affected.

The pedaling rate is defined as the number of revolutions of the crank shaft per unit time. This is also termed the cadence and is mostly defined as rounds per minute (rpm).

Although an optimal cadence is unique for every rider, it is clear that the human physiology in general does not allow large variations in cadence in order to maintain efficient power production and comfort.

Most modern bicycles are therefore equipped with some sort of variable gear mechanism to vary the relationship between the cadence and the rotational speed of the drive wheel. By changing the gear ratio, the desired cadence can be selected for different speeds and different cycling conditions, such as e.g. uphill or downhill.

The gear shift is performed by a gear shift mechanism. The type of gear shift mechanism will depend on the type of gear system used in the specific case.

However, efficient shifting of gears on a bicycle requires precision and timing. Experienced riders know that they should shift close to the dead point of the crank to reduce the torque from the riders feet present on the gear mechanism. A large torque makes shifting more difficult and will usually reduce the lifetime of the shift mechanism and the transmission.

E-bikes add more complexity to the gear shifting. In addition to the torque from the rider, the torque from the motor should be taken into account as well. If the experienced rider eases off the pedals for shifting, the shifting mechanism will still struggle if a large torque from the electric motor is present. Vice—versa will a large torque from the rider represent a problem for shifting, even in the event that the control system is able to reduce the torque from the motor during shifting temporarily.

Thus, there is a need for an improved shifting mechanism that takes the responsibility for smooth and efficient shifting off the experienced or less experienced rider.

WO2012128639A1 and WO2020130841 disclose multi-speed gear systems for a pedally propelled vehicle.

WO207149396 discloses a sequential gear shifter for a multi-speed system.

### SHORT SUMMARY

The invention is a vehicle gear shift system as set out in independent claim 1, where the problem identified above has been solved.

The shift system has one or more of the following advantages over prior art.

First of all, a multispeed gear system with the gear shift system according to the invention will in many situations shift more instantly than prior art solutions, and torque loss during shifting may be reduced.

In the case of a pedally propelled vehicle, the shifting will be more reliable and predictable, since it is less dependent on the behavior of the rider.

The gear shift system can in many cases easily be integrated with existing multi-speed gear systems.

The gear shift system comprises only a small number of components that are easily manufacturable.

The gear shift system requires little additional space over a prior art shift actuator without the additional features proposed.

The gear shift system can be used both for up- and down shifts.

The gear shift system can be used for different types of vehicle configurations, whether the multispeed gear system is arranged e.g. in the wheel hub or near the crank for pedally propelled vehicles, and for vehicles in general with or without motor support.

### BRIEF DESCRIPTION OF THE DRAWINGS

FIGS. 1 and 2 illustrate in isometric, partly cut away views, a gear shift system 1 according to an embodiment of the invention. Some of the features are hidden in FIG. 1, but are visible in the section view of FIG. 2.

FIG. 3 illustrates in a 3D model view the same embodiment of the invention as in FIGS. 1 and 2. A shift element 10 in the form of a shift-axle of a multi-speed gear system is illustrated partly transparent to show that the energy storage element 30 comprising a sleeve 34 is arranged inside the shift axle. The pin 32 is extending through the sleeve and further into the longitudinal grooves 11a, 11b in the inner wall of the shift axle and prevented from rotating relative to the shift axle.

FIG. 4 illustrates the energy storage element of FIG. 3 in more detail in a 3D model view. It can be seen that a coil spring 31, and a fixing member 33 are arranged inside the sleeve 34. The fixing member is arranged in a second end 34b of the sleeve, opposite a first end 34a. The pin 32 extends laterally through a through-bore of the fixing member and through opposite through-bores 35, 36 in the sleeve 34.

FIG. 5 illustrate in a view the same energy storage element 30, as in FIG. 4. It can be seen that the opposite through-bores 35, 36 each continue into two cuts 35a, 35b and 36a, 36b, respectively, extending in opposite curved or helical directions, from the through bore towards the first end of the sleeve. The complete cut comprising the through bore 35 and the two helically extending cuts 35a, 35b have the shape of a first “V”. The through cut 36 and the two helically extending cuts 36a, 36b defines a similar shaped “V” laterally opposite the first “V”. Further, it is seen that the first end of the sleeve 34a is configured to be connected to an energy source configured to rotate the sleeve relative the shift axle.

FIG. 6 illustrates in an exploded view the elements of the energy storage element 30 described previously. The spring is pre-loaded inside the sleeve after assembling. I.e. the first end of the spring abuts the inner wall of first end of the sleeve, and the second end abuts the fixing member that is pushed with a force into the sleeve before the pin is entered through the through bores in the sleeve and the fixing member.

FIG. 7a illustrates in a simplified block diagram an embodiment of how the control system 60 interacts with the energy source 20 and a gear operator 70 with a gear operator sensor 71. The gear operator sensor comprises an up-shift sensor 71a and a down-shift sensor 71b. When the rider activates the up-shift sensor, the control system 60 enables the energy source 20 to provide potential energy to the energy storage element. When the rider activates the down-shift sensor, the control system 60 enables the energy source 20 to provide potential energy to the energy storage element. However, the potential energy in the two cases have different signs. E.g. if the energy source is a motor, the motor will rotate in one direction when he up-shift sensor is pushed, and in the opposite direction when the down-shift sensor is pushed.

FIG. 7b illustrates in a simplified block diagram an embodiment of how the control system 60 interacts with the energy source 20 and a gear operator 70 with a gear operator sensor 71 in the same way as the embodiment in FIG. 7. In this case the vehicle comprises a drive motor 80 controlled by the control system.

FIG. 7c illustrates another embodiment of the control system, where the control system in addition to the features illustrated in FIG. 7b, operates based on the position of the shift element 2, as detected by the gear position detector 61. I.e., the control system may use the detected gear position as input for operating the energy source 20.

FIG. 8 illustrates in a partly schematic view, the gear shift system 1 mounted in an integrated pedaled vehicle crank mountable drive system. The drive system comprises a housing 2, with a crank shaft 3, an electric motor 80, and a multi-speed gear system 90. In this specific embodiment, the multi-speed gear system comprises planetary gear sets, and could e.g. be the type of gear disclosed in WO2020130841. Although not visible in the drawing, it will be understood that the gear shift system 1 operates a shift axle of the multi-speed gear system that is parallel to the crank axle. While the motor 20 is partly visible, the reduction gear 40 is located behind a cover. In this embodiment the control system 60 is also arranged inside the housing. In the figure, a gear operator 70 arranged on the handlebar is connected to the control system as described previously. A rechargeable battery 85 is connected to the control system and the other power consuming components, e.g., a drive motor drive circuit of the motor 20.

FIG. 9 illustrates the gear shift system 1 operating as a gear shift actuator of an internal multi-speed hub-gear of a pedally propelled vehicle. The multi-speed gear system 90 comprises planetary gear sets and could e.g. be the type of gear disclosed in WO2020130841. In this case, the motor 20 is arranged perpendicular to the embodiments shown previously, and the motor pinion gear 41 and the large diameter gear 42a of the first gearset 42 are bewel gears, where the reference numbers refer to the numbers of FIG. 1. The reduction gear 40 and the control system 60 are located behind the cover of the gear shift system. A battery 22 providing electric energy to the control system and the motor of the shift system is indicated as connected via electric connectors. The battery could e.g. be located inside the seat-pin or in any other suitable location. A wireless gear operator 70 arranged on the handlebar is connected to the control system.

### EMBODIMENTS OF THE INVENTION

In the following description, various examples and embodiments of the invention are set forth in order to provide the skilled person with a more thorough understanding of the invention. The specific details described in the context of the various embodiments and with reference to the attached drawings are not intended to be construed as limitations. Rather, the scope of the invention is defined in the appended claims.

The embodiments described below are numbered. In addition, dependent embodiments defined in relation to the numbered embodiments are described. Unless otherwise specified, any embodiment that can be combined with one or more numbered embodiments may also be combined directly with any of the dependent embodiments of the numbered embodiment(s) referred to.

EM 1: In this embodiment the invention is a vehicle gear shift system 1 comprising;
a movable shift element 10 configured to shift gears in a multispeed gear system of a vehicle;
an energy source 20;
an energy storage element 30;
wherein the energy source is configured to load or charge the energy storage element with potential energy, and the energy storage element is configured to move the shift element.

In a first dependent embodiment, the energy storage element is configured to move the shift element in two opposite directions from an equilibrium position wherein the energy storage element is not charged or loaded with energy from the energy source.

In a second dependent embodiment, that may be combined with the first dependent embodiment, the energy source is configured to load or charge the energy storage element with positive and negative potential energy relative to the equilibrium position. The sign of the energy depends on the shifting direction selected.

In a third dependent embodiment, that may be combined with the first or second dependent embodiment, the energy storage element is pre-loaded with energy in the equilibrium position.

EM 2: The pedally propelled vehicle gear shift system of EM1, comprising a control system 60, configured to control the energy provided from the energy source.

EM 3: The pedally propelled vehicle gear shift system of EM2, wherein the control system is configured to initiate energy delivery from the energy source to the energy storage element at a start time T0 and to end energy delivery a pre-defined timespan TS1 after the start time.

In a first dependent embodiment the gear shift system comprises a gear operator 70 comprising a gear operator sensor 71 connected to the control system and configured to detect one or more gear shifts of the gear operator wherein the control system is configured to set the start time TO when a gear shift is detected by the gear operator sensor.

In a second dependent embodiment, dependent on the first dependent embodiment, the control system is configured to initiate energy delivery when the gear operator sensor detects a single gear shift.

In a third dependent embodiment, dependent on the first or second dependent embodiment, the control system is configured to initiate energy delivery when the gear operator sensor detects a double gear shift, wherein the timespan for the double shift is twice the timespan for the single shift.

In a fourth dependent embodiment, the control system comprises a cadence detector, and the control system is configured to initiate energy delivery when the cadence detected from the cadence detector is above or equal to an upper threshold or below or equal to a lower threshold.

In a fourth dependent embodiment the pre-defined timespan TS1 is less than 0.5 s, less than 0.3 s or less than 0.2 s for a single gear shift.

In a fifth dependent embodiment the sign of the energy delivery depends on whether the control system initiates an up-shift or a down-shift.

In a sixth dependent embodiment, the gear shift element comprises end-stops for the upper and/or lower gear.

In a seventh dependent embodiment, the control system is configured to move the shift element until the end-stops for the upper and/or lower gear has been reached as part of an initialization process.

EM 4: The vehicle gear shift system of EM2, comprising a gear position detector 61 connected to the control system.

In a dependent embodiment, the control system is configured to end energy delivery when the position detector indicates that at least one gear has been shifted.

EM 5: The vehicle gear shift system of any of EM 1 to EM 4, wherein the energy source is a motor configured to provide rotational energy.

In a first dependent embodiment, the control system is configured to control start and stop of the motor.

In a second dependent embodiment, that may be combined with the first dependent embodiment, the control system is configured to operate the motor in forward and reverse directions.

EM 6: The vehicle gear shift system of EM 5, comprising a speed reduction mechanism 40 arranged between the energy source and the energy storage element, wherein the speed reduction mechanism is arranged to transfer energy from the motor to the energy storage element.

In a first dependent embodiment, the speed reduction mechanism is a reduction gear.

In a second dependent embodiment, dependent on the first dependent embodiment, the reduction gear is a single-input/single-output reduction gear.

The reduction gear may in embodiments be a double or triple reduction gear.

EM 7: The vehicle gear shift system of any of EM 1 to EM6, wherein the energy storage element comprises a resilient mechanical element 31 configured to be elastically deformed between an input and an output.

In a first dependent embodiment, the inputs and outputs of the resilient mechanical element are connected to the energy source and the movable shift element, respectively. Optionally the input is connected via the reduction mechanism 40.

In a second dependent embodiment, that may be combined with the first dependent embodiment, the resilient mechanical element is mechanically pre-loaded. I.e. it is elastically deformed when there is no energy provided from the energy source.

EM 8: The vehicle gear shift system of any of EM 1 to EM7, wherein the movable shift element is a shift axle.

In a first dependent embodiment, the shift axle is configured to rotate to shift gears of the multispeed gear system.

EM 9: The vehicle gear shift system of EM 7 and EM 8, wherein the resilient mechanical element is a spring configured to be loaded with potential energy.

In a first dependent embodiment, the resilient mechanical element is a coil spring.

In a second dependent embodiment, dependent on the first dependent embodiment, the coil spring is pre-loaded by compression by a force of at least 0.1 or 0.2 Nm.

In a second dependent embodiment the shift axle comprises one or more longitudinal grooves in its inner wall 11a, 11b, and the energy storage element comprises a pin 32 adjacent to the output or second end 31b of the coil spring, wherein the end or ends of the pin is arranged in the one or more grooves in the inner wall of the shift axle and prevented from rotating relative to the shift axle but allowed to move longitudinally relative to the shift axle. The pin is configured to compress the spring when pushed against the second end of the spring.

In a third dependent embodiment that may be combined with the second dependent embodiment, the energy storage element comprises a fixing member 33 comprising a radial guiding protrusion that extends into the second end of the coil spring, wherein the pin is arranged in a transversal bore of the fixing member.

EM 10: The vehicle gear shift system of EM 9, wherein the energy storage element comprises a sleeve 34 with first and second ends 34a, 34b arranged longitudinally inside the shift axle, wherein the spring and the fixing member are arranged inside the sleeve, and wherein the fixing member is configured to rotate and slide inside the sleeve.

In a first dependent embodiment, an outer diameter of the sleeve is similar to an inner diameter of the shift axle in a cross section.

EM 11: The vehicle gear shift system of EM 10, wherein a wall of the second end of the sleeve, comprises a through bore for the pin.

In a first dependent embodiment, wherein the spring is a coil spring, the position of the through bore corresponds to the position of the pin when the coil spring is in equilibrium position, i.e., not compressed or loaded with potential energy from the energy source.

In a second dependent embodiment, that may be combined with the first dependent embodiment, the wall of the second end 34b of the sleeve comprises two cuts 35a, 35b and 36a, 36b extending in opposite directions from the through bore towards the first end of the sleeve.

The cuts may be curved along the circumference of the wall of the sleeve, wherein a lateral component of the curve increases faster than a longitudinal component for a curve segment of the curve in the direction from the second end to the first end of the sleeve.

The cuts may be symmetrical about the longitudinal axis.

In a third dependent embodiment, that may be combined with the second dependent embodiment, the circumferential length of each of the cuts correspond to at least a rotation of the pin and the shift axle one single gear shift. I.e. if a single gear shift corresponds to a 10 degree rotation of the shift axle, the circumferential length of the cut corresponds to the arc of a sector where the radius is the radius of the sleeve and the angle of the sector is 10 degree.

In a fourth dependent embodiment that may be combined with the second or third dependent embodiment, the longitudinal length of the cuts corresponds to at least the compression of the spring when the pin and the shift axle are rotated one single gear shift.

In a fifth dependent embodiment, that may be combined with the any of the second to fourth dependent embodiments, the length of the cuts in the wall of the sleeve corresponds to at least a rotation of the pin and the shift axle one doble gear shift or two consecutive single gear shifts. The circumferential length of the cuts allows the pin to rotate two consecutive gear shifts, i.e. 20 degree if each shift is 10 degree as explained above.

In a sixth dependent embodiment, that may be combined with the any of the second to fourth dependent embodiments, the longitudinal length of the cuts corresponds to at least the compression of the spring when the pin and the shift axle one doble gear shift or two consecutive single gear shifts.

The cuts allow the pin to move in the longitudinal and rotational direction with regard to the sleeve, as constrained by the cuts.

Further, and according to any of the embodiments where the pin or sleeve or shift axle are mentioned, these elements may be symmetrical about a longitudinal plane, where the shift axle comprises two opposite longitudinal grooves, the pin has two protruding ends arranged in respective longitudinal grooves in the shift axle, and the sleeve comprises two opposite through bores for the pin.

The pin is forced into the through bore of the sleeve by the force of the spring. The spring may also be pre-loaded as explained previously. When the sleeve is rotated by the energy source, e.g. the motor, via the reduction gear the pin will rotate the shift axle accordingly. This is the case when the shift axle rotates freely and do not set up any counter torque.

In the case where the shift axle resists rotation due to a counter torque, the pin will be pushed laterally and longitudinally from the through bore into the cuts of the sleeve. However, since the cuts have a longitudinal component, the coil spring will be compressed in the longitudinal direction and the torque of the pin acting on the shift axle increases more and more when the spring is compressed. When the torque of the pin increases above the absolute value of the counter torque, the potential energy of the spring is released in a very short time when the spring expands and the pin is forced to follow the curved path of the cuts.

In the case where the resilient mechanical element, i.e. the spring is pre-loaded by compression, the pin will remain in the through bore as long as the absolute value of the counter torque is lower than the torque resulting from the pre-loaded spring, pushing the pin towards the second end of the sleeve 34b.

The embodiments 9 to 11 above describe a gear shift system based on energy storage in a compressed spring. However, energy may in another embodiment be stored in a rotated or twisted resilient element.

EM 12: The vehicle gear shift system of any of EM 1 to EM 8, wherein the spring is configured to store rotational potential energy.

In a first dependent embodiment, a first end of the resilient element is connected to the energy source 20, wherein the energy source is configured to rotate the first end of the spring.

In a second dependent embodiment, that may be combined with the first dependent embodiment, the second end of the resilient element is rotationally connected to a shift axle of a multispeed gear system and the resilient element is configured to rotate the shift axle when a torque of the second end of the resilient element increases above the counter torque of the shift axle.

In a third dependent embodiment, that may be combined with the first or second dependent embodiment, the resilient element is a torsion spring.

In a fourth dependent embodiment, that may be combined with any of the first to third dependent embodiments, the resilient element is pre-loaded in one or two rotational directions. Alternatively, two springs may be used that are pre-loaded in opposite rotational directions.

The energy source may in any of the embodiments be e.g. an electric motor, a solenoid or a hydraulic or pneumatic motor.

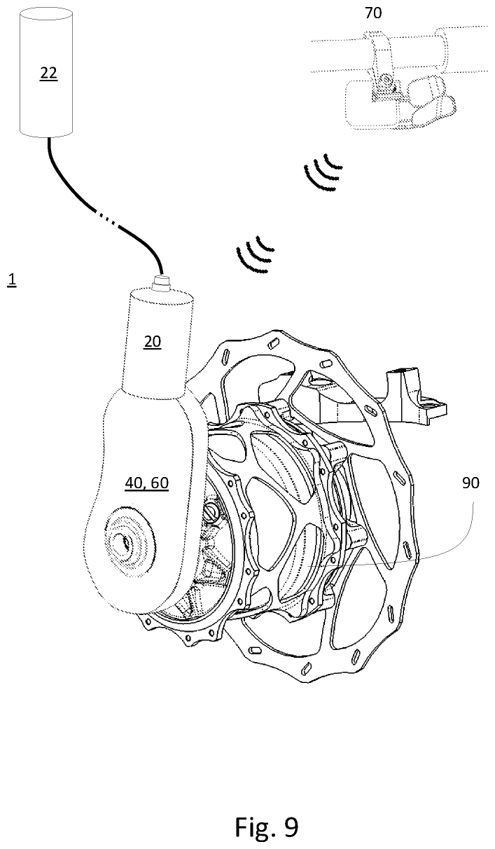

The gear shift system may in any of the embodiments be hollow, where any of the sleeve, resilient element, fixing member etc. are hollow. This allows a wheel bolt through the gear shift system in the case where the gear shift system is arranged in a wheel hub, as illustrated in FIG. 9.

The gear shift system may be part of an inventive vehicle in different configurations as further described in the embodiments below.

EM 13: A vehicle, comprising;
a crankshaft with pedal arms,
a drive wheel,
a transmission arranged between the crankshaft and the driving wheel, comprising;
a multispeed gear system,
wherein a gear ratio of the transmission can be varied by shifting gear in the multispeed gear system;
a vehicle gear shift system according to any of the embodiments EM 1 to EM 12.

EM 14: The vehicle of EM 13, comprising an electric drive motor 80.

EM 15: The vehicle of EM 13 or EM 14, wherein the multispeed gear system and the energy storage element is arranged in the hub of the driving wheel.

EM 16: The vehicle of EM 13 or EM 14, comprising a housing 2, wherein the crankshaft 3, the multispeed gear system 90 and the energy storage element 85 are at least partly arranged inside the housing.

EM 17: The vehicle of any of EM 3, and EM 14 to EM 16, wherein the control system is configured to control the electric drive motor.

In a first dependent embodiment electric drive motor is configured to drive an input of the multi-speed gear system, and the control system is configured to decrease torque from the electric drive motor after the start time TO.

In a second dependent, that may be combined with the first dependent embodiment, embodiment the control system is configured to decrease torque from the electric drive motor at the timespan T1.

The invention is also a novel and inventive method for gear shifting of a vehicle as described in the embodiments below:

EM 18: A method for shifting gear of a vehicle comprising
a multispeed gear system,
a vehicle gear shift system comprising a movable shift element configured to shift gears in the multispeed gear system,
an energy source, and
an energy storage element configured to move the shift element, wherein the method comprises;
initiating energy delivery from the energy source to the energy storage element at a start time TO and to end energy delivery a pre-defined timespan TS1 after the start time.

EM 19: The method for shifting gear of a vehicle according to EM 18, wherein the vehicle comprises;
an electric drive motor, and the method comprises;
decrease torque from the electric drive motor after the start time TO.

The features of EM 18 and EM19 may in related embodiments be according to EM 1 to EM 12.

In any of the embodiments above, the vehicle may be a pedally propelled vehicle and/or the vehicle gear shift system may be a pedally propelled vehicle gear shift system.

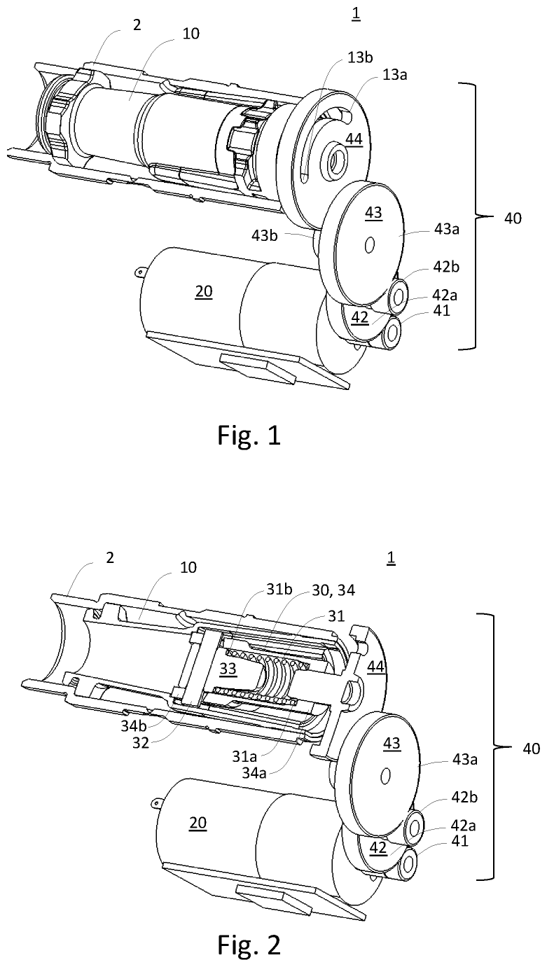

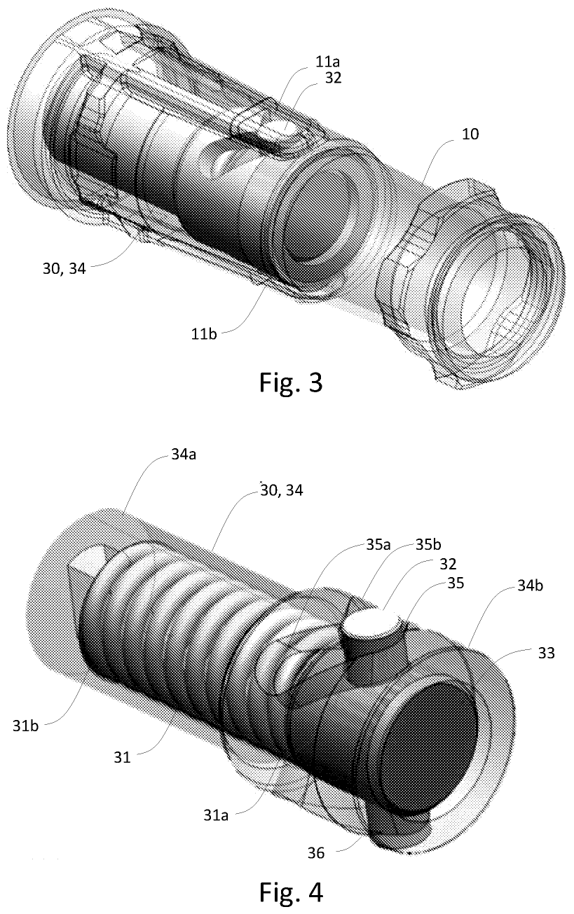

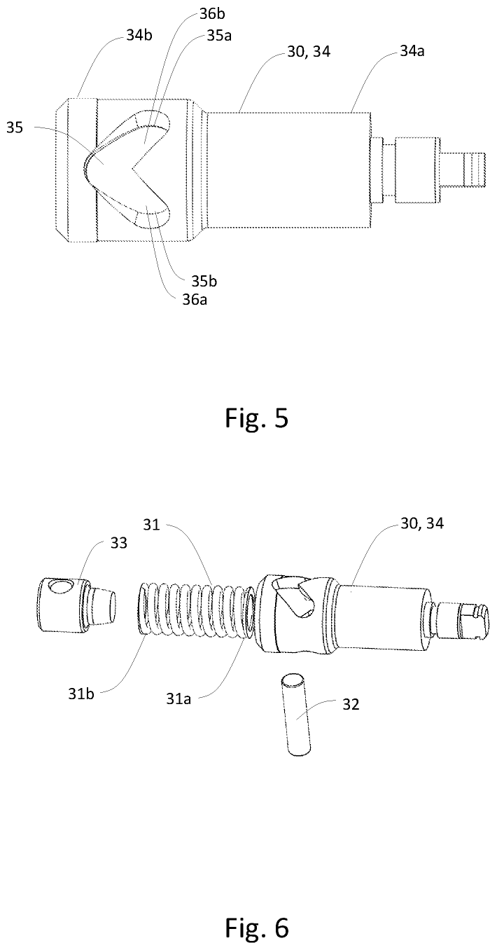

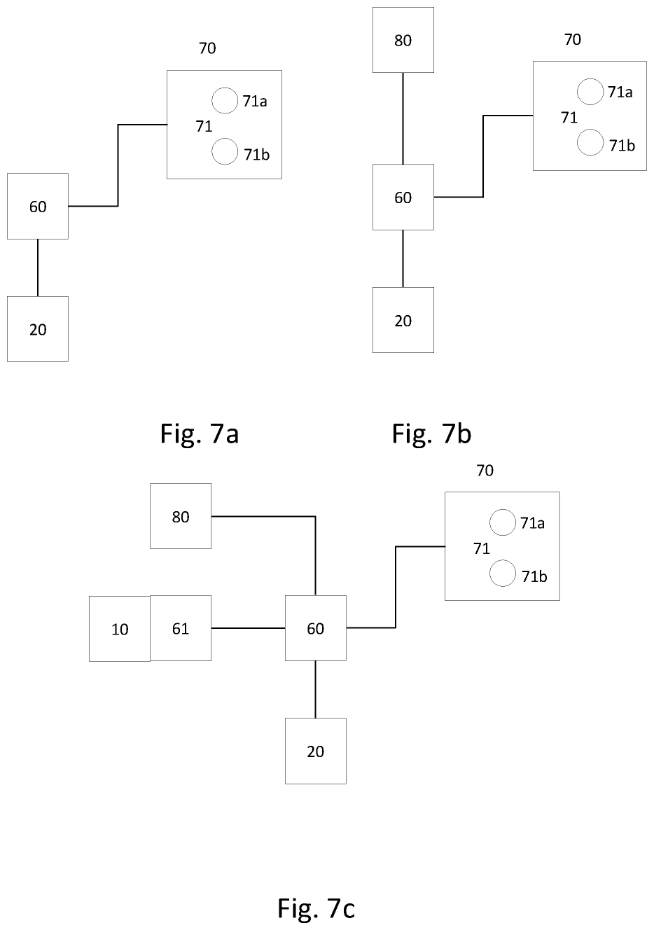

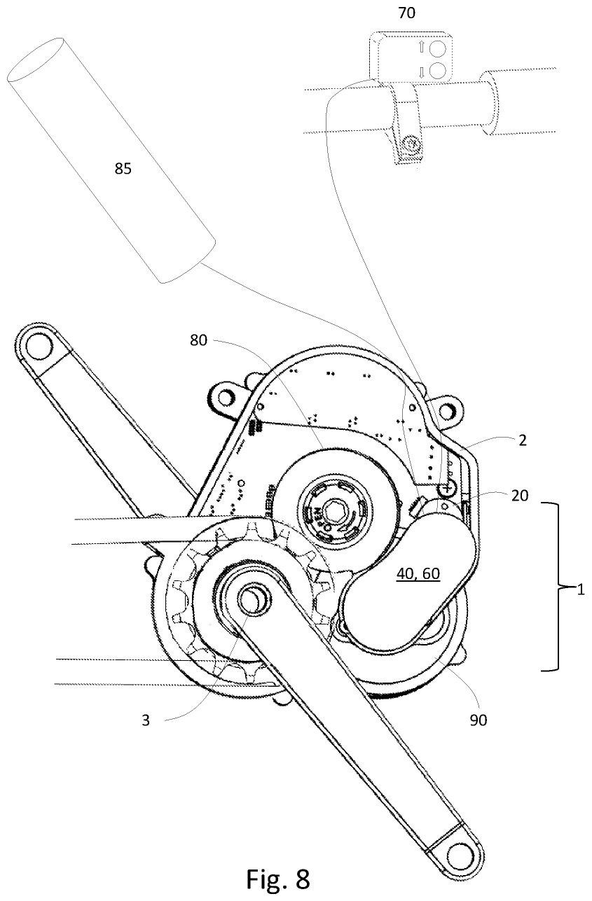

In a specific embodiment illustrated in FIGS. 1 and 2, the vehicle gear shift system 1 comprises a movable shift element 10 configured to shift gears in a multispeed gear system of a vehicle. In this case, the shift element is a hollow shift axle that is arranged inside a gearbox. When the shift axle is rotated relative to the gearbox, the gear ratio of the gearbox will change according to prior art.

Depending on the type of gear mechanism used inside the gearbox, the shift axle may interact with the gears of the gearbox via e.g. clutches or pawls.

The gear shift system 1 further comprises an energy source 20 in the form of an electric motor with a drive shaft arranged in parallel with the shift axle. The electric motor is powered by a battery and controlled by a control system.

An energy storage element 30 comprising a pre-loaded coil spring is arranged co-axially inside the hollow shift axle.

Further details of each of these elements in this specific embodiment are given below.

The reduction gear is single-input/single-output, triple reduction gear and comprises first and second toothed gearsets 42, 43 between the motor shaft and the coil spring 31. A large diameter gear 42a of the first gearset 42 is meshing with a pinion gear 41 on the motor shaft. The first gearset comprises a small diameter gear 42b meshing with a large diameter gear 43a of the second gearset 43. Finally, a small diameter gear 43b is meshing with a large diameter shift shaft gear 44 coaxially connected to the first end 34a of a sleeve 34.

The type of reduction gear has been chosen to allow a motor small in size and power to load, i.e. compress, the coil spring with sufficient potential energy in the first part of a shift action as described previously. If a larger motor is used, a smaller reduction gear e.g. a double or single reduction gear, may be used instead. The coil spring is dimensioned to be compressed the amount of two consecutive gear shifts. E.g. if a 10-degree rotation of the shift axle represents one gear shift and 20-degree represents two consecutive gear shifts, the coil spring must allow the compression from a 20-degree twist during the load period for this embodiment. However, if only a single gear shift is required, the compression can be reduced. Similarly, three consecutive shifts would require a larger compression, but it would also require longer time to load with the same motor and reduction gear.

The sleeve 34 is comprises the coil spring. The first end of the sleeve is further connected directly to the shift shaft gear 44, and the sleeve is in this way rotated in a fixed proportional relationship with the motor, determined by the gear ratio of the reduction gear.

The outer diameter of the second end of the sleeve 34b corresponds in a cross section to the inner diameter of the shift axle, such that the sleeve is stabilized radially in its second end. In the first end the sleeve and the shift shaft gear are supported in the radial direction by a ball bearing 35 in the housing wall 2. In the longitudinal direction the sleeve is locked by a narrowing of the inner diameter of the shift axle.

The second end 31b of the coil spring is pushing a transversal pin 32, also comprised by the energy storage element extending into longitudinal grooves 11a, 11b of the inner wall of the shift axle 10. Thus, the pin is fixed in the rotational direction relative to the shift axle since it is prevented from rotating by the walls of the grooves. However, it may move in the longitudinal direction along the grooves.

The energy storage element further comprises a fixing member 33 arranged inside the second end of the sleeve. The fixing member has a guiding protrusion that extends into the second end of the coil spring.

The fixing member further has a transversal through bore for the pin.

The fixing member may move both rotationally and longitudinally inside the sleeve. However, these movements are constrained by the compression of the spring and the pin.

In the second end of the sleeve, first and second opposite through bores 35, 36 are made for the pin. The position of the through bores corresponds to the position of the pin when the coil spring is not twisted.

From each of the through bore, two cuts 35a, 35b and 36a, 36b are extending in opposite helical or curved directions towards the first end of the sleeve. The cuts allow the pin to move in the longitudinal and rotational direction with regard to the sleeve, as constrained by the cuts. The circumferential length of the cuts allow the pin to rotate two consecutive gear shifts, i.e. 20 degree if each shift is 10 degree as explained above.

When the sleeve is twisted by the motor in a first direction, and the shift axle is rotationally fixed by a counter torque, the first end of the pin will move helically or curved from the through bore 35 into the first cut 35a. The second end of the pin will move from through bore 36 on the opposite side and helically or curved along the first opposite cut 36a.

When the sleeve is rotated by the motor in a second direction, opposite the first direction, and the shift axle is rotationally fixed by a counter torque, the first end of the pin will move from the through bore 35 curved or helically in the second cut 36a. The second end of the pin will move from through bore 36 on the opposite side and helically or curved along the second opposite cut 36b.

The coil spring is locked in its second end by the fixing member in the longitudinal direction, which in turn is locked by the pin to the sleeve. The end of the sleeve abuts a narrowed part of the inner diameter of the shift axle. When the coil spring is in the locked position, it is pre-loaded by compression, and the pin will not be able to move from its initial position if it is not exposed to a torque that overcomes the pre-load force.

The motor 20 is operationally connected to a control system 60, and via a motor controller circuit (not shown) the start and stop in forward or reverse directions and the speed of the motor can be controlled.

A stepwise explanation of a gear shift will be given in the following section.

As soon as the control system detects that a gear shift is requested, e.g. from a sensor of a gear shift operator, a shift command is sent to the motor that will start rotating the sleeve via the reduction gear. As long as the motor continues to rotate the sleeve, the torque from the pin acting on the shift axle will increase.

As explained initially, the torque required to rotate the shift axle from one position to the next, heavily depends on the pedaling force of the rider and the drive motor, when this is used.

The following scenarios may then be envisaged where the vehicle is a pedally propelled vehicle:

In a first scenario the rider releases pressure on the pedals when shifting. In this scenario very little torque is required to rotate the shift axle and the shift axle will start rotating right after the beginning of the twist, i.e. right after the start time TO. The shift axle continues to rotate until the end of the timespan T1, when it has reached its next position.

In a second scenario the rider continues to put pressure on the pedals after shifting up or down. A considerable torque is required to rotate the shift axle and shift gear and the shift will take place some time after the start time T1 when the torque that is building up on the pin overcomes the counter torque in the gearbox. The shift axle continues to rotate until the end of the timespan T1, when it has reached its next position.

In a third scenario the rider puts a lot of pressure on the pedals—a pressure resulting in a counter torque that is larger than the maximum torque that can be delivered by the shift system. In this case the motor will stop after a pre-determined maximum time, such as 0.1 s, without the gear shift taking place. However, as soon as the pressure on the pedals is released to below the maximum torque, a delayed gear shift will take place. This happens typically when the crank arms are in the top/bottom dead center position of the pedal stroke, i.e. the crank arms are vertical. Since the gear shift takes place with maximum torque from the energy storage element, it will be instant and ready for continued pressure when the crank arms have overcome the dead position.

In a fourth scenario, the pedally propelled vehicle has a drive motor providing torque in addition to the pedal generated torque. This is similar to the third scenario, but the control system may here decrease the torque from the motor a short period at the end of timespan T1 to reduce the total torque input to the multi-speed gear system to allow the shifting to take place.

The scenarios for a double shift will be similar to the scenarios for a single shift, except that the motor will have a twisting time, i.e. a time span T2 that is longer than the timespan T1 time for a single shift. The corresponding torque will also increase with increased twisting time.

In this case the control system detects that a double gear shift is requested, and the motor start twisting. It will continue to twist until the end of timespan T2 has been reached and the gear has shifted two positions up or down. Shifting will take place in a similar manner as indicated for the scenarios above.

In the exemplary embodiments, various features and details are shown in combination. The fact that several features are described with respect to a particular example should not be construed as implying that those features by necessity have to be included together in all embodiments of the invention. Conversely, features that are described with reference to different embodiments should not be construed as mutually exclusive. As those with skill in the art will readily understand, embodiments that incorporate any subset of features described herein and that are not expressly interdependent have been contemplated by the inventor and are part of the intended disclosure. However, explicit description of all such embodiments would not contribute to the understanding of the principles of the invention, and consequently some permutations of features have been omitted for the sake of simplicity or brevity.

1. A vehicle gear shift system comprising:
a movable shift element configured to shift gears in a multispeed gear system of a vehicle;
an energy source; and
an energy storage element,
wherein the energy source is configured to load or charge the energy storage element with potential energy, and the energy storage element is configured to move the shift element.

2. The vehicle gear shift system of claim 1, further comprising a control system configured to control the energy provided from the energy source.

3. The vehicle gear shift system of claim 2, wherein the control system is configured to initiate energy delivery from the energy source to the energy storage element at a start time T0 and to end energy delivery a pre-defined timespan TS1 after the start time.

4. The vehicle gear shift system of claim 1, wherein the energy source is a motor configured to provide rotational energy.

5. The vehicle gear shift system of claim 4, further comprising a speed reduction mechanism arranged between the energy source and the energy storage element,
wherein the speed reduction mechanism is arranged to transfer rotational energy from the motor to the energy storage element.

6. The vehicle gear shift system of claim 1, wherein the energy storage element comprises a resilient mechanical element configured to be elastically deformed between an input and an output.

7. The vehicle gear shift system of claim 6, wherein the resilient mechanical element is mechanically pre-loaded.

8. The vehicle gear shift system of claim 1, wherein the movable shift element is a shift axle configured to rotate to shift gears of the multispeed gear system.

9. The vehicle gear shift system of claim 6, wherein the resilient mechanical element is a spring configured to be loaded with potential energy.

10. The vehicle gear shift system of claim 9, wherein the shift axle comprises one or more longitudinal grooves in an inner wall thereof, and the energy storage element comprises a pin extending laterally through at least one through-bore in the sleeve, and
wherein the end or ends of the pin is arranged in the one or more grooves in the inner wall of the shift axle and prevented from rotating relative to the shift axle, but allowed to move longitudinally relative to the shift axle.

11. A vehicle, comprising:
a crankshaft with pedal arms;
a drive wheel;
a transmission arranged between the crankshaft and the driving wheel, the transmission comprising a multispeed gear system, wherein a gear ratio of the transmission can be varied by shifting gears in the multispeed gear system; and
the vehicle gear shift system according to claim 1.

12. The vehicle gear shift system of claim 2, wherein the energy source is a motor configured to provide rotational energy.

13. The vehicle gear shift system of claim 3, wherein the energy source is a motor configured to provide rotational energy.

14. The vehicle gear shift system of claim 2, wherein the energy storage element comprises a resilient mechanical element configured to be elastically deformed between an input and an output.

15. The vehicle gear shift system of claim 3, wherein the energy storage element comprises a resilient mechanical element configured to be elastically deformed between an input and an output.

16. The vehicle gear shift system of claim 4, wherein the energy storage element comprises a resilient mechanical element configured to be elastically deformed between an input and an output.

17. The vehicle gear shift system of claim 5, wherein the energy storage element comprises a resilient mechanical element configured to be elastically deformed between an input and an output.

18. The vehicle gear shift system of claim 2, wherein the movable shift element is a shift axle configured to rotate to shift gears of the multispeed gear system.

19. The vehicle gear shift system of claim 3, wherein the movable shift element is a shift axle configured to rotate to shift gears of the multispeed gear system.

20. The vehicle gear shift system of claim 4, wherein the movable shift element is a shift axle configured to rotate to shift gears of the multispeed gear system.
